(19) United States
(12) Patent Application Publication
(10) Pub. No.: US 2026/0203943 A1
(43) Pub. Date: Jul. 16, 2026

(54) USER-FACING SENSOR CALIBRATION FOR HEAD-MOUNTED DISPLAYS

(71) Applicant: GOOGLE LLC, Mountain View, CA (US)

(72) Inventors: Zhiheng Jia, Sunnyvale, CA (US); Hao Wu, San Francisco, CA (US); Eric M. Meisner, Montclair, NJ (US); Mingsong Dou, Cupertino, CA (US); Luke Song, Milpitas, CA (US); Jason Todd Spencer, Rocklin, CA (US); Xiao Yuan, Palo Alto, CA (US); Chao Guo, Los Altos, CA (US)

(21) Appl. No.: 19/133,390

(22) PCT Filed: Dec. 5, 2023
(86) PCT No.: PCT/US2023/082502

§ 371 Date: May 28, 2025

Related U.S. Application Data
(60) Provisional application No. 63/386,125, filed on Dec. 5, 2022.

(51) Int. Cl. G06T 7/80; G06F 3/01; H04N 17/00

(52) U.S. Cl. CPC G06T 7/80; H04N 17/002; G06F 3/013; G06T 2207/30244

(57) ABSTRACT

Techniques include calibrating the user-facing sensors using a calibration target in world space. A calibration target in this case includes an LED panel that is mounted on a linear rail, and a jig for mounting a head-mounted display (HMD) having user-facing sensors such that the user-facing sensors face the LED panel. On the HMD, there are at least two user-facing cameras; an eye-tracking (ET) camera and a face-tracking (FT) camera. There are also a plurality of LEDs associated with an ET camera. In some implementations, the LEDs surround the ET camera. The cameras are calibrated simultaneously—that is, the camera intrinsics and extrinsics relative to a base, i.e., the LED panel in a base position, are determined in a single step after data has been collected. In another, separate step, the ET camera LEDs are calibrated—that is, their positions relative to the ET camera are determined.

### BACKGROUND

Calibration of user-facing sensors on a head-mounted display (HMD) involves imaging a calibration target from each sensor and determining camera intrinsics (e.g., focal length, principal point, distortion) and camera extrinsics between, e.g., different cameras or between a camera and a display.

### SUMMARY

Implementations described herein are related to a system and method for calibrating user-facing sensors in a head-mounted display (HMD) for use in an augmented reality (AR)/virtual reality (VR)/mixed reality (MR) system. The system includes a calibration target external to the head-mounted display and a jig for mounting the HMD such that the user-facing cameras face the calibration target. In some implementations, the calibration target is mounted in a mount that can move the calibration target toward or away from the HMD. The calibration target has an array of LEDs on it that can be turned on or off. When the LEDs of the calibration target are turned on, the user-facing cameras can each capture an image of the calibration target at different distances from a baseline position. Based on the image from the user-facing cameras, camera intrinsics such as imaging parameters of the user-facing cameras (e.g., focus, principal planes, distortion) can be determined. In some implementations, a rotation and translation of each user-facing camera with respect to the baseline position of the calibration target is also determined. When the LEDs of the calibration target are turned off, light sources associated with an eye-tracking camera are turned on. The eye-tracking camera captures an image of the reflected glints of the light sources on the calibration target. Based on the image from the eye-tracking camera and the intrinsics of the eye-tracking camera determined from the previous image, the position of the light source relative to the eye-tracking camera is determined.

In one general aspect, a (computer-implemented) method can include capturing a first image of a calibration target with a user-facing camera of a head-mounted display (HMD). The method can also include determining an imaging parameter of the user-facing camera of the HMD based on the first image of the calibration target, the imaging parameter representing at least one physical characteristic of the user-facing camera. The method can further include capturing a second image of the calibration target with the user-facing camera of the HMD. The method can further include determining a position relative to the user-facing camera of a light source of the HMD based on the second image and the imaging parameter of the user-facing camera.

In another general aspect, a computer program product can include a non-transitory storage medium, the computer program product including code that, when executed by processing circuitry, causes the processing circuitry to perform a method. The method can also include determining an imaging parameter of the user-facing camera of the HMD based on the first image of the calibration target, the imaging parameter representing at least one physical characteristic of the user-facing camera. The method can further include capturing a second image of the calibration target with the user-facing camera of the HMD. The method can further include determining a position relative to the user-facing camera of a light source of the HMD based on the second image and the imaging parameter of the user-facing camera.

In another general aspect, a system can include a calibration target. The system can also include a mount for the calibration target. The system can further include a jig configured to mount a head mounted display (HMD) such that a user-facing camera of the HMD faces the calibration target when the calibration target is mounted on the mount. The system can further include processing circuitry (e.g., of the HMD). The processing circuitry can be configured to capture a first image of the calibration target mounted on the mount with a user-facing camera of a head-mounted display (HMD) mounted on the jig. The processing circuitry can also be configured to determine an imaging parameter of the user-facing camera of the HMD based on the first image of the calibration target, the imaging parameter representing at least one physical characteristic of the user-facing camera. The processing circuitry can further be configured to capture a second image of the calibration target with the user-facing camera of the HMD. The processing circuitry can further be configured to determine a position relative to the user-facing camera of a light source of the HMD based on the second image and the imaging parameter of the user-facing camera.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example system involving a head-mounted display (HMD) with user-facing cameras and light sources and a calibration target.

FIG. 2 is a diagram that illustrates an example calibration target.

FIG. 3 is a diagram that illustrates an example calibration target in a mount.

FIG. 4 is a diagram that illustrates an example calibration target with reflected glints from light sources associated with the eye-tracking (ET) camera on the HMD.

FIG. 5 is a diagram that illustrates an example configuration of ET camera and light source with respect to the reflected glint on the calibration target.

FIG. 6 is a diagram that illustrates an example electronic environment in which the improved techniques described herein may be implemented.

FIG. 7 is a flow chart that illustrates an example method of calibrating user-facing sensors on an HMD, according to disclosed implementations.

### DETAILED DESCRIPTION

Calibration of user-facing sensors on an AR/VR/MR device involves imaging a calibration target from each sensor and determining camera intrinsics (e.g., focal length, principal point, distortion). An example of a calibration target is a patterned object attached to an inside surface of an arm of the AR/VR/MR device, in user space.

It is noted that, in this context, user-facing sensors include eye-tracking (ET) cameras, face-tracking (FT) cameras, and light sources associated with the ET cameras. In some implementations, the light sources associated with the ET cameras are light-emitting diodes (LEDs) surrounding each ET camera. The ET cameras are configured to capture images of a user's pupil to determine, e.g., a gazing direction of the eye. A FT camera is configured to capture images of a user's face to determine emotion or mood.

A technical problem with the above is that such a calibration of the user-facing sensors can be cumbersome. For example, existing calibration techniques use a calibration pattern attached to the HMD, e.g., on the inside of an arm of the frame.

In accordance with the implementations described herein, a technical solution to the above-described technical problem includes calibrating the user-facing sensors using a calibration target in world space. A calibration apparatus in this case includes an LED panel coated with a reflective material (e.g., Mylar) that is mounted on a linear rail, and a jig for mounting a head-mounted display (HMD) having user-facing sensors such that the user-facing sensors face the LED panel. On the HMD, there is at least one user-facing camera; an eye-tracking (ET) camera. There is also a plurality of light sources associated with the ET camera. In some implementations, the light sources are LEDs. In some implementations, the LEDs surround the ET camera. The camera is calibrated—that is, the camera intrinsics and rotation and translation relative to a base, i.e., the LED panel in a base position, are determined after data has been collected. In another, separate step, the ET camera light sources are calibrated—that is, their positions relative to the ET camera are determined.

To calibrate the ET camera, the LED panel is mounted at the base position and the HMD is mounted in the jig such that the ET camera faces the LED panel. The LEDs in the LED panel are turned on, and the light sources associated with the ET cameras are turned off. Each camera captures an image of the LED panel. The LED panel is then moved outward with respect to the HMD along the linear rail and the process is repeated at a few steps along the outward movement, e.g., at 0 cm, 2 cm, 4 cm from the base position. Due to mounting errors, the plane of the LED panel may not be perpendicular to the rail motion direction. Accordingly, in addition to camera intrinsics, rotation, and translation relative to the base position, in some implementations a target plane rotation relative to the base is also determined. Data acquired from these steps are input into a cost function such that the cost function is reduced (e.g., minimized) or a value of the cost function is reduced below a nominal value.

In some implementations, there are multiple user-facing cameras. In some implementations, there is a face-tracking (FT) camera in addition to the ET camera. There may be a pair of ET and FT cameras on the HMD. In some implementations, the multiple user-facing cameras are calibrated simultaneously by defining a single cost function that depends on the intrinsics of each user-facing camera. In some implementations, the cost function also depends on the rotations and translations of each user-facing camera relative to the base, and these rotations and translations are determined, along with the intrinsics, by minimizing the cost function.

To calibrate the light sources associated with the ET cameras, the LEDs on the LED panel are turned off, and the light sources associated with the ET camera are turned on. On the LED panel, glints, or reflections of the light from the light sources off the LED panel, may be observed. In some implementations in which the light sources associated with the ET camera surround the ET camera, the glints are arranged in a ring on the LED panel. Given the ET camera position and the glint positions on the LED panel over multiple reflection planes, the light source position on the HMD relative to the ET camera is determined by triangulation. In some implementations, the positions of the light sources may be determined via minimization of a cost function.

A technical advantage of disclosed implementations is that the intrinsics of user-facing sensors, including LEDs associated with an ET camera, can be determined easily. Moreover, in the case of multiple user-facing cameras, with a simple transformation the extrinsics of the user-facing cameras (e.g., the positions and orientations of the user-facing cameras with respect to one another) can also be determined with the intrinsics.

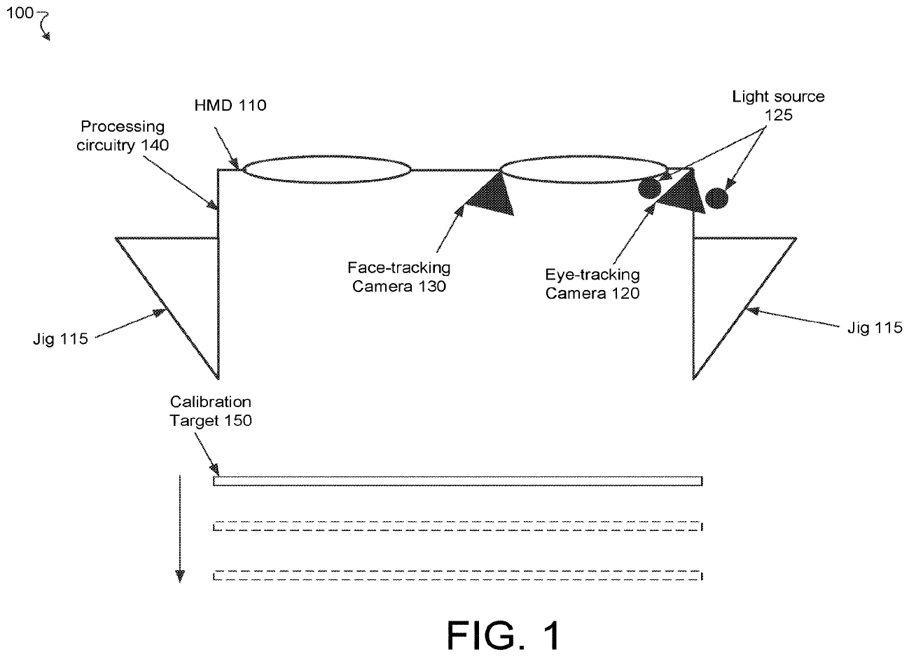

FIG. 1 is a diagram that illustrates an example configuration as system 100 involving a head-mounted display (HMD) 110 with user-facing cameras and light sources and a calibration target. As shown in FIG. 1, the system 100 includes a HMD 110 mounted in a jig 115, and a calibration target 150.

The HMD 110 is configured for use in a virtual reality (VR) system, an augmented reality (AR) system, and/or a mixed reality (XR) system. The HMD 110 includes an eye-tracking (ET) camera 120 with an associated light source 125, a face-tracking (FT) camera 130, and processing circuitry 140. As shown in FIG. 1, the HMD 110 is mounted in the jig 115 such that the ET camera 120 and FT camera 130 are facing the calibration target 150.

The ET camera 120 is configured to track movement of a user's eye by capturing images of the user's eye in rapid succession. The ET camera 120 is controlled by the processing circuitry 140, and the images of the user's eye are analyzed by the processing circuitry 140 to determine gaze angle, for example.

The light source 125 is associated with the ET camera 120 and is configured to provide lighting for the ET camera 120. In some implementations, the light source 125 includes a set of LEDs which surround the ET camera 120. The light source 125 is configured to illuminate the iris of the eye so that the eye can be imaged by the ET camera 120. For the imaging to be useful, the location of the light source 125, e.g., the location of the LEDs surrounding the ET camera 120, may need to be known to a high degree of accuracy.

The FT camera 130 is configured to track movement of the user's face by capturing images of the user's face in rapid succession. The FT camera 130 is controlled by the processing circuitry 140, and the images of the user's face are analyzed by the processing circuitry 140 to determine perception, for example.

The processing circuitry 140 is configured to capture a first image of a calibration target with a user-facing camera of a head-mounted display (HMD); determine an imaging parameter of the user-facing camera of the HMD based on the first image of the calibration target, the imaging parameter representing at least one physical characteristic of the user-facing camera; capture a second image of the calibration target with the user-facing camera of the HMD; and determine a position relative to the user-facing camera of a light source of the HMD based on the second image and the imaging parameter of the user-facing camera. In some implementations, the processing circuitry 140 is located on the HMD 125 and is the processing circuitry used by the HMD 125. In some implementations, however, the processing circuitry 140 is external to the HMD 125 and is contained in, e.g., a computer connected to the HMD 125.

The calibration target 150 is configured to provide images by which the ET camera 120, the light source 125, and the FT camera 130 may be calibrated. The calibration target 150 is mounted on a mount (not pictured) that provides motion toward and away from the HMD 110. The movement of the calibration target 150 is controlled by a motor (not pictured) that moves the calibration target 150 in steps of equal length. For example, the calibration target 150 is moved to a secondary position and a secondary image is captures with the user-facing camera. The imaging parameter of the user-facing camera may then be determined based also on the secondary image.

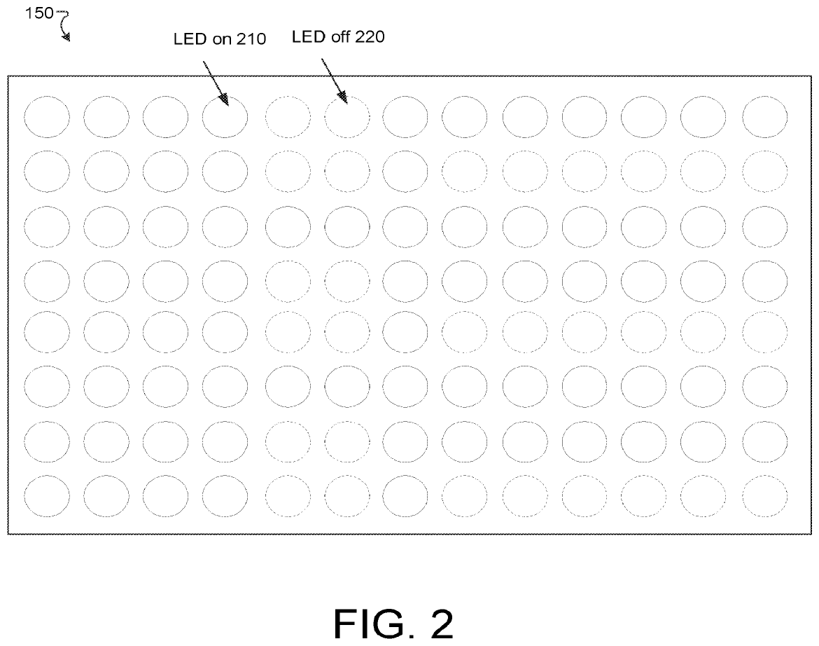

Further details of the calibration target 150 are discussed with regard to FIG. 2.

FIG. 2 is a diagram that illustrates an example calibration target 150. The calibration target 150 includes an array of LEDs, each of which can be turned on 210 or off 220 individually or all together. When the LEDs are turned on, some of the LEDs can be turned off so that the illuminated LEDs form a calibration pattern.

As shown in FIG. 2, the LEDs are all the same size. Nevertheless, in some implementations, the LEDs can be of different sizes. In some implementations, the LEDs come in two sizes. Thie different sizes along with the pattern of on vs off LEDs form a basis for a calibration pattern.

As shown in FIG. 2, the LEDs have a circular shape. Nevertheless, in some implementations, the LEDs can be of a different shape, e.g., rectangular, square, triangular, polygonal, etc.

In some implementations, the calibration target is coated with a reflective material, e.g., mylar. This aids the calibration of the light sources associated with the ET camera on the HMD.

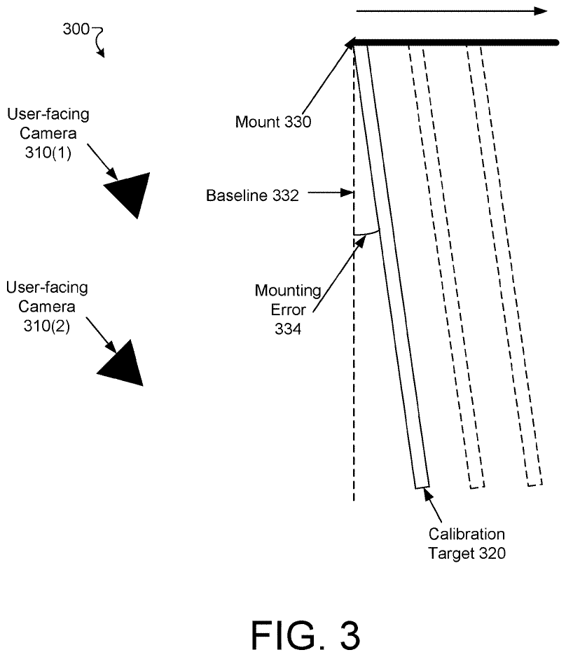

FIG. 3 is a diagram that illustrates an example calibration target 320 in a mount 330. As shown in FIG. 3, the calibration target 320 is imaged by two user-facing cameras 310(1) and 310(2).

The calibration process involves mounting the calibration target 320 on the mount 330. In some implementations, the mount 330 takes the form of a linear rail that may be moved via a motor (not pictured). The mount 330 sets the calibration target 320 at a specified distance (e.g., 10 cm) from the HMD, e.g., HMD 110; this is the baseline 332. LEDs on the calibration target are turned on so that a calibration pattern is formed.

The user-facing cameras 310(1) and 310(2) capture images of the calibration target with the LEDs turned on. Once this is done, the calibration target is moved in the linear rail away from the user-facing cameras 310(1) and 310(2) a specified distance (e.g., 2 cm) and the user-facing cameras 310(1) and 310(2) capture images of the calibration target at the new distance. The process is repeated for a specified number of times (e.g., 3).

Once the images are captured, the intrinsics (e.g., physical parameters) of the user-facing cameras 310(1) and 310(2), as well as their rotation and translation relative to the baseline 322, may be determined. In some implementations, the intrinsics are determined via a cost function. In some implementations, the cost function is as follows:

$${arg min}_{K , R , T} {\sum }_{i = 1}^{I} \vert project ( K , [ R \vert T ] \cdot {P}_{i} ) - {p}_{i} \vert$$

where Pᵢ is a 3D target point in base (the first target pose) space, pᵢ is an observed target point on camera image plane space, K is the camera intrinsic (physical) parameters (e.g., focus, principal plane, distortion). R and T is the rotation and translation between a user-facing camera 310(1) or 310(2), and project is a camera projection function.

It is noted that the “argmin” notation in the above cost function, and in subsequent cost functions herein, does not necessarily imply an exact minimization of the cost function. Rather, the imaging parameter found may be one that reduces the value of the cost function below a nominal value of the cost function. A nominal value of the cost function represents a value of the cost function evaluated with nominal parameters on which the cost function depends that is not a minimum. e.g., an initial value or an intermediate value. In some implementations, the parameters K, R, and T that “minimize” the cost function may in fact reduce the value of the cost function to within, e.g., 10%, 5%, 2%, 1% or less of a true minimum value of the cost function.

Once the intrinsics have been determined for each camera, the extrinsics between cameras may be determined via a simple transformation. For example, the translation between the user-facing camera 310(1) and the user-facing camera 310(2) is given by

$${}_{1}^{2} T {=}_{base}^{1} {{T}^{- 1}}_{base}^{2} T ,$$

where

$${}_{1}^{2} T$$

is the translation between user-facing camera 310(1) and 310(2),

$${base}_{1}^{} T$$

is the translation (determined via the cost function) between the user-facing camera 310(1) and the baseline 322, and

$${base}_{2}^{} T$$

is the translation between the user-facing camera 310(2) and the baseline 322. A similar formulation applied to the rotation.

In some implementations, there may be a mounting error 334 that results in the calibration target 320 not being parallel to the baseline 322, but rather forming a nonzero angle with the baseline 322. In this case, the camera intrinsics as well as the camera rotation and translation may be determined via a cost function as above, but the cost function becomes more complex because the mounting error is unknown. Nevertheless, the cost function may be written in a form in which the intrinsics of all cameras may be determined simultaneously.

$${arg min}_{{K}_{j} , {R}_{j} , {T}_{j} , {q}_{base}^{target}} {\sum }_{j = 1}^{J} {\sum }_{i = 1}^{I} \vert project ( {K}_{j} , [ {R}_{j} \vert {T}_{j} ] \cdot ( QuatToRot ( {q}_{base}^{target} ) \cdot {P}_{{i}_{target}} + {t}_{base}^{target} ) ) - {p}_{i} \vert + \vert tan\_z ( {q}_{base}^{target} ) \vert$$

where Kⱼ, Rⱼ, Tⱼ are the intrinsics, rotation, and translation of the jth camera relative to the baseline 322;

$${q}_{base}^{target}$$

is the target plane rotation relative to the baseline 322,

$${t}_{base}^{target}$$

is the translation of target relative to baseline 322; Pᵢ_{_{target}} is a 3D target point in target space; pᵢ is an observed target point on camera image plane space; and project is camera projection function. It is noted that rotation and translation of a camera refers to a 6DoF pose of the camera relative to the baseline.

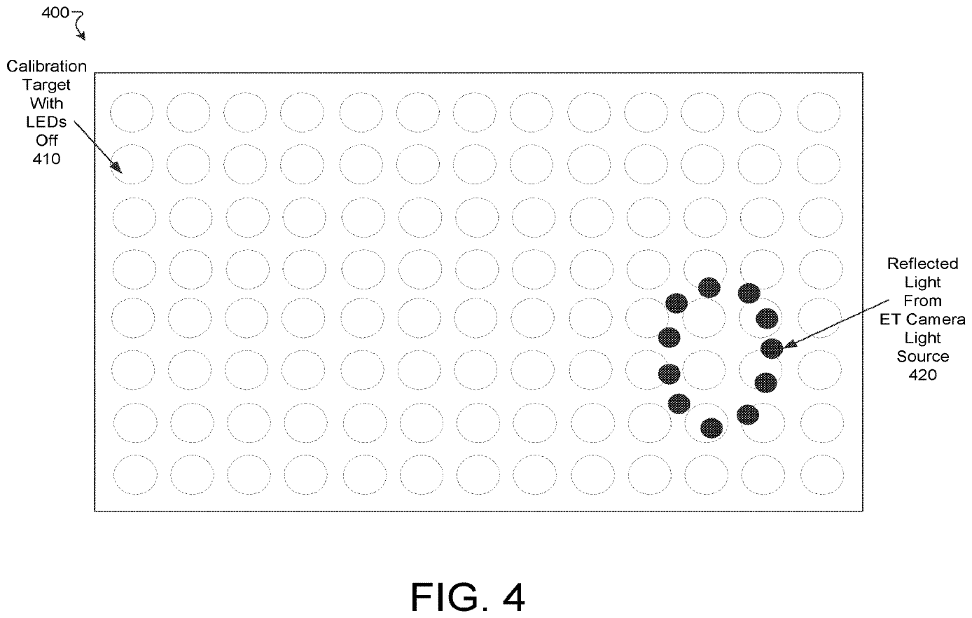

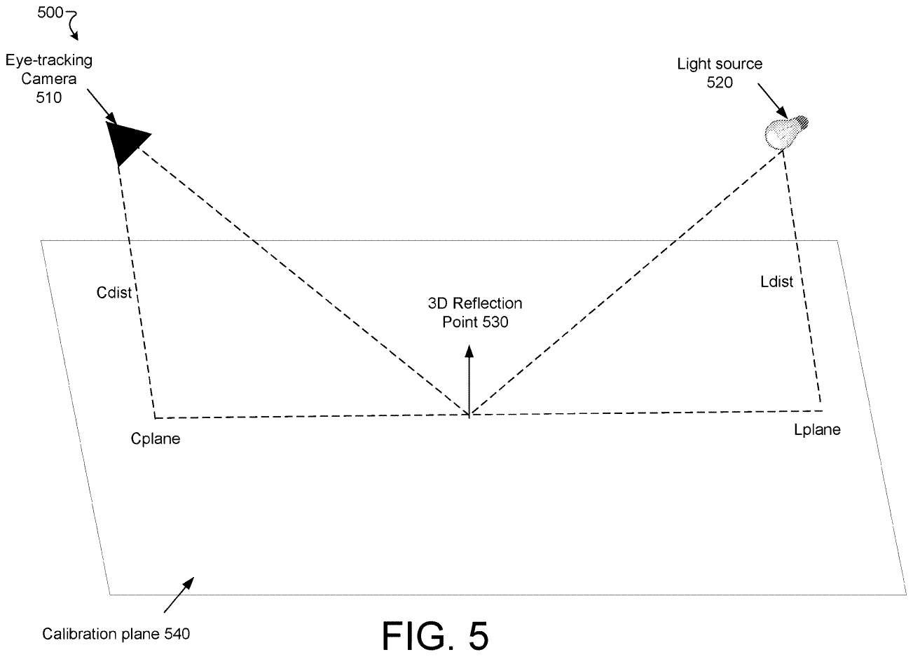

The result of the camera calibration using the calibration target 320 with LEDs on is the intrinsics, or physical parameters, of each camera, the rotation and translation of each camera with respect to a baseline, and the extrinsics of pairs of cameras. Nevertheless, the positions of the light sources associated with the ET cameras are to be determined; the positions of the light sources are needed for the imaging of the eye from the ET camera to be meaningful. Accordingly, a calibration procedure for determining the positions of the light sources associated with the ET camera is presented with regard to FIGS. 4 and 5.

FIG. 4 is a diagram that illustrates an example calibration target 410 with reflected glints 420 from light sources associated with the eye-tracking (ET) camera on the HMD. To assist in observing the reflected glints 420, the calibration target 410 may be coated with a reflective material such as mylar. In this way, the calibration target 410 acts as a mirror which reflects the light sources associated with the ET camera.

The positions of the reflected glints 420 on the calibration target 410 may be measured. Moreover, the intrinsics and the pose (e.g., rotation and translation with respect to a baseline) were determined in the user-facing camera calibration described with regard to FIG. 3. It is accordingly left to determine the pose of the calibration target 410 with respect to the baseline and the transformation of the points on the calibration target 410 back into ET camera space.

Such a determination may be accomplished by minimizing, or reducing the value from a nominal value, of certain cost functions. The cost functions are as follows.

### Optimization Parameters:

{qᵢ, tᵢ}: The pose of each calibration target position i as a quarternion and translation vector in ET camera space.
Lⱼ: The 3D positions of the eye-tracking LEDs in ET camera space.

### Inputs

It is assumed that known calibration targets p_{i,k}∈ project(Pₖ; C, {qᵢ, tᵢ}) and LED reflected glints l_{i,j}∈ project(Lⱼ; C) have been detected and are provided as 2D pixel locations. Note that i indexes a calibration target position, j indexes an LED, and k indexes a point in the calibration target. Pₖ are the 3D position of the calibration targets, Lⱼ are the 3D positions of the LEDs, and C is the ET camera position. Note that, while the LED positions do not vary with target position, their reflected glints do. The target positions are defined in target space and are transformed to ET camera space using {qᵢ, tᵢ}.
It is assumed that some initial estimates of Pₖ and Lⱼ are given. For example, the Pₖ may be given by calibration detection libraries, while the Lⱼ may be given by a device computer-aided design (CAD) model.
project(; C) is an operator that projects a 3D point into an image of the ET camera C. It is assumed that the camera intrinsics are known (e.g., from the camera calibration with regard to FIG. 3) and that the ET camera is located at zero.

### Cost Functions

### Reprojection Error

$${arg min}_{{q}_{i} , {t}_{i}} {\sum }_{i , k} \vert project ( {P}_{k} ; C , \{ {q}_{i} , {t}_{i} \} ) - {p}_{i , k} \vert$$

The reprojection error penalizes the projection of the calibration target coordinate Pₖ into the camera image. By first transforming Pₖ to ET camera space using {qᵢ, tᵢ}, the values of qᵢ, tᵢ are driven to the correct solution.

### Ray to LED Error

$${arg min}_{{q}_{i} , {t}_{i} , {L}_{j}} {\sum }_{i , j} \vert Ref ( Ray ( {I}_{i , j} ; C ) , {q}_{i} , {t}_{i} ) - {L}_{j} \vert$$

The Ray to LED error uses the ray induced by the ET camera and the LED glint detection l_{i,j}. The intersection and reflection Ref( ) of this ray from the calibration target should pass through the 3D position of Lⱼ for each i and j. This helps drive the qᵢ, tᵢ, Lⱼ to the correct solution.

### LED to Ring Centroid Error

$${arg min}_{{L}_{j} , {L}_{center}} {\sum }_{j} \vert ‖ {L}_{j} - {L}_{center} ‖ - radius \vert$$

A latent variable that represents the centroid of the LED ring L_{center} is maintained and the distance of each LED from the ring center is penalized. The distance from the the center, radius, is a constant and defined by the CAD model. Note that in this construction, the centroid L_{center} is moved by consensus of the LEDs.

FIG. 5 is a diagram that illustrates an example configuration 500 of ET camera 510 and light source 520 with respect to the reflected glint 530 on a calibration plane 540. Such a configuration 500 can simplify the determination of a position of the light source 520 with respect to the ET camera 510.

A benefit of using planar mirrors (e.g., a calibration target coated with a reflective substance such as mylar) for calibration of the light source 520 is that the reflection and projection of a given light source 520 into the ET camera 510 can be simulated easily. This is done by first computing the nearest point on the plane of the calibration target 540 to the ET camera 510 and the light source 520. Given the nearest points on the plane to the ET camera 510 and light source 520 (Cplane and Lplane, respectively), the position of the normal bisector is known to be along the line segment between Cplane and Lplane, which lies in the transformed calibration plane 540, defined by {qᵢ, tᵢ}. Using similar triangles, it is known that the distances along the segment from Cplane to the bisector and from Lplane to the bisector are proportional to their duals (ET camera 510 and light source 520, respectively). Using this, the location of the reflected glint 530 can be determined by interpolating along the segment defined by the points Cplane and Lplane. The reflected glint 530 can then be reprojected into the ET camera 510 to simulate a detection of the light source 520.

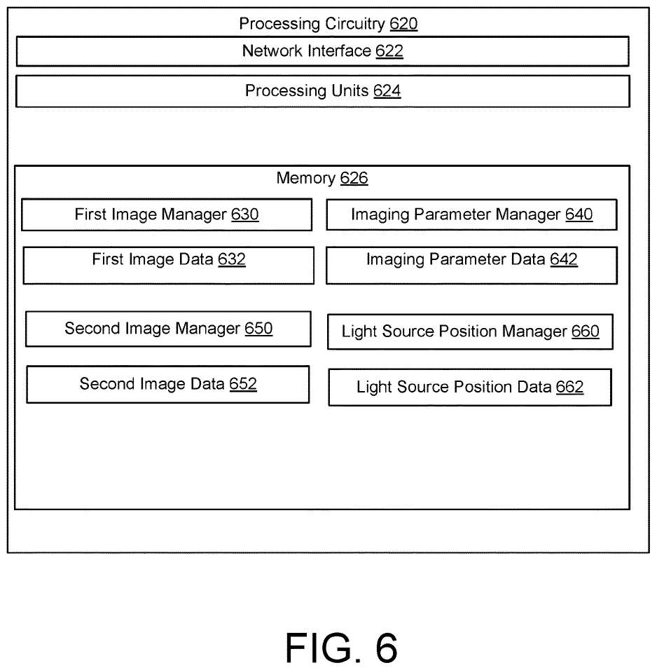

FIG. 6 is a diagram that illustrates an example electronic apparatus in which the above-described technical solution may be implemented. The processing circuitry 620 is configured to perform a calibration of user-facing cameras and light sources associated with an ET camera to determine the intrinsics and extriinsics of the user-facing cameras and the positions of the light sources with respect to an ET camera. In an example, the processing circuitry 620 is the processing circuitry 140 of the HMD 110 of FIG. 1. In another example, the processing circuitry 620 is part of a device external to the HMD 110, e.g., being communicatively connected to the HMD.

The processing circuitry 620 includes a network interface 622, one or more processing units 624, and memory 626. The network interface 622 includes, for example, Ethernet adaptors, Token Ring adaptors, and the like, for converting electronic and/or optical signals received from the network to electronic form for use by the processing circuitry 620. The set of processing units 624 include one or more processing chips and/or assemblies. The memory 626 includes both volatile memory (e.g., RAM) and non-volatile (nontransitory) memory, such as one or more ROMs, disk drives, solid state drives, and the like.

In some implementations, one or more of the components of the processing circuitry 620 can be, or can include processors (e.g., processing units 624) configured to process instructions stored in the memory 626 that cause the processing circuitry to perform a method of performing a calibration of user-facing cameras and light sources associated with an ET camera. Examples of such instructions as depicted in FIG. 6 include a first image manager 630, an imaging parameter manager 640, a second image manager 650, and a light source position manager 660. Further, as illustrated in FIG. 6, the memory 626 is configured to store various data, which is described with respect to the respective managers that use such data.

The first image manager 630 is configured to capture a first image of a calibration target with a user-facing camera of an HMD to produce first image data 632. In some implementations, the calibration target is external to the HMD. In some implementations, the calibration target includes a set of LEDs, wherein at least one of the set of LEDs is turned on. In some implementations, the calibration target is mounted on a linear rail and is configured to be moved in a direction toward or away from the user-facing camera.

The imaging parameter manager 640 is configured to determine an imaging parameter (imaging parameter data 642) of the user-facing camera of the HMD based on the first image of the calibration target, the imaging parameter representing at least one physical characteristic of the user-facing camera. For example, the imaging parameter data 642 may represent a focus, a principal plane, or a distortion of the user-facing camera. In some implementations, the imaging parameter manager 640 is configured to find as the imaging parameter a reducing imaging parameter that reduces the value of a cost function below a nominal value. In some implementations, the cost function has a value that indicates a deviation of a predicted image point from an observed image point.

In some implementations, the imaging parameter manager 640 is configured to find a rotation and translation of the user-facing camera relative to a base position of the calibration target (e.g., baseline position 322 of FIG. 3) that reduces the value of the cost function below the nominal value of the cost function. In such an implementation, the imaging parameter data 642 includes the rotation and translation of the user-facing camera relative to the base.

The second image manager 650 is configured to obtain a second image (second image data 542) of the calibration target with the user-facing camera of the HMD. In some implementations, the LEDs of the calibration target are turned off. In some implementations, the calibration target is coated with a reflective material, e.g., mylar. In some implementations, the second image is an image of a reflection of a light source of the HMD on the calibration target using the user-facing camera in a pose. In some implementations, the light source includes a ring of LEDs surrounding the user-facing camera, and the image of the reflection is an image of a ring of reflected glints on the calibration target.

The light source position manager 660 is configured to determine a position relative to the user-facing camera (light source position data 662) of a light source of the HMD based on the second image and the imaging parameter of the user-facing camera. In some implementations, the light source position manager 660 determines the position by optimizing a cost function representing ray to LED error.

The components (e.g., modules, processing units 624) of the processing circuitry 620 can be configured to operate based on one or more platforms (e.g., one or more similar or different platforms) that can include one or more types of hardware, software, firmware, operating systems, runtime libraries, and/or so forth. In some implementations, the components of the processing circuitry 620 can be configured to operate within a cluster of devices (e.g., a server farm). In such an implementation, the functionality and processing of the components of the processing circuitry 620 can be distributed to several devices of the cluster of devices.

The components of the processing circuitry 620 can be, or can include, any type of hardware and/or software configured to process attributes. In some implementations, one or more portions of the components shown in the components of the processing circuitry 620 in FIG. 6 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 620 can be, or can include, a software module configured for execution by at least one processor (not shown). In some implementations, the functionality of the components can be included in different modules and/or different components than those shown in FIG. 6, including combining functionality illustrated as two components into a single component.

Although not shown, in some implementations, the components of the processing circuitry 620 (or portions thereof) can be configured to operate within, for example, a data center (e.g., a cloud computing environment), a computer system, one or more server/host devices, and/or so forth. In some implementations, the components of the processing circuitry 620 (or portions thereof) can be configured to operate within a network. Thus, the components of the processing circuitry 620 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, the memory 626 can be any type of memory such as a random-access memory, a disk drive memory, flash memory, and/or so forth. In some implementations, the memory 626 can be implemented as more than one memory component (e.g., more than one RAM component or disk drive memory) associated with the components of the processing circuitry 620. In some implementations, the memory 626 can be a database memory. In some implementations, the memory 626 can be, or can include, a non-local memory. For example, the memory 626 can be, or can include, a memory shared by multiple devices (not shown). In some implementations, the memory 626 can be associated with a server device (not shown) within a network and configured to serve the components of the processing circuitry 620. As illustrated in FIG. 6, the memory 626 is configured to store various data, including first image data 632, imaging parameter data 642, second image data 652, and light source position data 662.

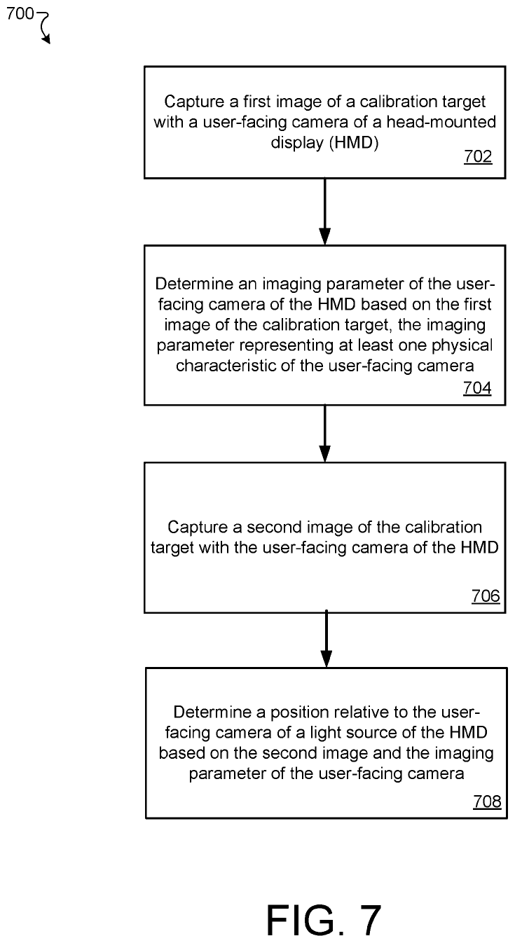

FIG. 7 is a flow chart depicting an example method 700 of performing a calibration of user-facing cameras and light sources associated with an ET camera. The method 700 may be performed by software constructs described in connection with FIG. 6, which reside in memory 626 of the processing circuitry 620 and are run by the set of processing units 624.

At 702, the first image manager 630 captures a first image of a calibration target with a user-facing camera of an HMD.

At 704, the imaging parameter manager 640 determines an imaging parameter of the user-facing camera of the HMD based on the first image of the calibration target, the imaging parameter representing at least one physical characteristic of the user-facing camera. To provide an example, the first image may be analyzed. For example, the calibration pattern in the first image may be analyzed to determine the imaging parameter(s). For example, the calibration pattern in the first image may be compared with a reference pattern, wherein a deviation to the reference pattern indicates the imaging parameter, or the like. Alternatively. or in addition, a cost function can be used to determine the imaging parameter(s).

At 706, the second image manager 650 captures a second image of the calibration target with the user-facing camera of the HMD.

At 708, the light source position manager 660 determines a position relative to the user-facing camera of a light source of the HMD based on the second image and the imaging parameter of the user-facing camera. To provide an example, the second image may be analyzed. For example, the position(s) of reflection(s) (e.g., glints 420) in the second image may be analyzed to determine the position of the light source). For example, the position(s) may be compared with reference positions and/or a reprojection may be performed and/or a cost function may be minimized, or the like.
Clause 1. A method, comprising: capturing a first image of a calibration target with a user-facing camera of a head-mounted display (HMD); determining an imaging parameter of the user-facing camera of the HMD based on the first image of the calibration target, the imaging parameter representing at least one physical characteristic of the user-facing camera; capturing a second image of the calibration target with the user-facing camera of the HMD; and determining a position relative to the user-facing camera of a light source of the HMD based on the second image and the imaging parameter of the user-facing camera.
Clause 2. The method as in clause 1, wherein the calibration target is external to the HMD.
Clause 3. The method as in any of clauses 1 or 2, wherein the calibration target includes a set of light-emitting diodes (LEDs).
Clause 4. The method as in clause 3, wherein, in the first image, at least one LED of the set of LEDs of the calibration target are turned on.
Clause 5. The method as in any of clauses 3 or 4, wherein, in the second image, the set of LEDs are turned off.
Clause 6. The method as in any of clauses 1-5, wherein determining the imaging parameter of the user-facing camera of the HMD includes: defining a value of a cost function that indicates a deviation of a predicted image point from an observed image point, the cost function depending on an imaging parameter of the user-facing camera; and finding, as the imaging parameter, a reducing imaging parameter of the user-facing camera that reduces the value of the cost function below a nominal value of the cost function.
Clause 7. The method as in clause 6, wherein the cost function further depends on a rotation and translation of the user-facing camera relative to a base position of the calibration target; and wherein the method further comprises: finding a rotation and translation of the user-facing camera relative to the base position of the calibration target that reduces the value of the cost function below the nominal value of the cost function.
Clause 8. The method as in any of clauses 1-7, wherein the calibration target is mounted on a linear rail and is configured to move in a direction away from or toward the user-facing camera.
Clause 9. The method as in clause 8, wherein capturing the first image of a calibration target includes: capturing the first image of the calibration target at a base position with the user-facing camera; moving the calibration target to a secondary position; and capturing a secondary image of the calibration target at the secondary position with the user-facing camera; wherein the imaging parameter of the user-facing camera of the HMD is determined based on the first image and the secondary image.
Clause 10. The method as in any of clauses 8 or 9, wherein amounting error results in a rotation of the calibration target about a base position of the calibration target; and wherein determining the imaging parameter of the user-facing camera of the HMD includes: defining a value of a cost function that indicates a deviation of a predicted image point from an observed image point, the cost function depending on an imaging parameter of the user-facing camera and the rotation of the calibration target about the base position of the calibration target; and finding, as the imaging parameter, a reducing imaging parameter of the user-facing camera and a rotation of the calibration target about the base position of the calibration target that reduce the value of the cost function below a nominal value of the cost function.
Clause 11. The method as in any of clauses 1-10, wherein the user-facing camera is a first user-facing camera; and wherein the method further comprises: obtaining a further image of the calibration target with a second user-facing camera of the HMD; determining an imaging parameter of the second user-facing camera of the HMD based on the further image of the calibration target, the imaging parameter of the second user-facing camera defining at least one physical characteristic of the second user-facing camera; and determining a relative pose between the first user-facing camera and the second user-facing camera.
Clause 12. The method as in any of clauses 1-11, wherein capturing the second image of the calibration target with the user-facing camera of the HMD includes: capturing an image of a reflection of the light source of the HMD on the calibration target using the user-facing camera in a pose.
Clause 13. The method as in clause 12, wherein the image of the reflection of the light source of the HMD on the calibration target is a first image of the reflection of the light source of the HMD on the calibration target and the pose is a first pose; and wherein the method further comprises: capturing a second image of the reflection of the light source of the HMD on the calibration target using the user-facing camera in a second pose.
Clause 14. A computer program product comprising a nontransitory storage medium, the computer program product including code that, when executed by processing circuitry, causes the processing circuitry to perform the method as in any of clauses 1-13.
Clause 15. A system, comprising: a calibration target; a mount for the calibration target: a jig configured to mount a head-mounted display (HMD) such that a user-facing camera of the HMD faces the calibration target; and processing circuitry configured to: capture a first image of a calibration target with a user-facing camera of a head-mounted display (HMD); determine an imaging parameter of the user-facing camera of the HMD based on the first image of the calibration target, the imaging parameter representing at least one physical characteristic of the user-facing camera; capture a second image of the calibration target with the user-facing camera of the HMD; and determine a position relative to the user-facing camera of a light source of the HMD based on the second image and the imaging parameter of the user-facing camera.
Clause 16. The system as in clause 15, wherein the processing circuitry configured to determine the imaging parameter of the user-facing camera of the HMD is further configured to: define a value of a cost function that indicates a deviation of a predicted image point from an observed image point, the cost function depending on an imaging parameter of the user-facing camera; and find, as the imaging parameter, a reducing imaging parameter of the user-facing camera that reduces the value of the cost function below a nominal value of the cost function.
Clause 17. The system as in clause 16, wherein the cost function further depends on a rotation and translation of the user-facing camera relative to a base position of the calibration target; and wherein the processing circuitry is further configured to: find a rotation and translation of the user-facing camera relative to the base position of the calibration target that reduces the value of the cost function below the nominal value of the cost function.
Clause 18. The system as in any of clauses 15-17, wherein the calibration target is mounted on a linear rail and is configured to move in a direction away from or toward the user-facing camera.
Clause 19. The system as in clause 18, wherein the processing circuitry configured to capture the first image of a calibration target is further configured to: capture the first image of the calibration target at a base position with the user-facing camera; move the calibration target to a secondary position; and capture a secondary image of the calibration target at the secondary position with the user-facing camera; wherein the imaging parameter of the user-facing camera of the HMD is determined based on the first image and the secondary image.
Clause 20. The system as in any of clauses 18 or 19, wherein a mounting error results in a rotation of the calibration target about a base position of the calibration target; and wherein the processing circuitry configured to determine the imaging parameter of the user-facing camera of the HMD is further configured to: define a value of a cost function that indicates a deviation of a predicted image point from an observed image point, the cost function depending on an imaging parameter of the user-facing camera and the rotation of the calibration target about the base position of the calibration target; and find, as the imaging parameter, a reducing imaging parameter of the user-facing camera and a rotation of the calibration target about the base position of the calibration target that reduce the value of the cost function below a nominal value of the cost function.
Clause 21. The system as in any of clauses 15-20, wherein the user-facing camera is a first user-facing camera; and wherein the processing circuitry is further configured to: obtain a further image of the calibration target with a second user-facing camera of the HMD; determine an imaging parameter of the second user-facing camera of the HMD based on the further image of the calibration target, the imaging parameter of the second user-facing camera defining at least one physical characteristic of the second user-facing camera; and determine a relative pose between the first user-facing camera and the second user-facing camera.
Clause 22. The system as in any of clauses 15-21, wherein the processing circuitry configured to capture the second image of the calibration target with the user-facing camera of the HMD is further configured to: capture an image of a reflection of the light source of the HMD on the calibration target using the user-facing camera in a pose.
Clause 23. The system as in clause 22, wherein the image of the reflection of the light source of the HMD on the calibration target is a first image of the reflection of the light source of the HMD on the calibration target and the pose is a first pose; and wherein the processing circuitry is further configured to: capture a second image of the reflection of the light source of the HMD on the calibration target using the user-facing camera in a second pose.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “nontransitory machine-readable medium” “nontransitory computer-readable medium” refers to any computer program product, apparatus and/or device (e.g., magnetic discs, optical disks, memory. Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keytarget and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

It will also be understood that when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application may be amended to recite example relationships described in the specification or shown in the figures.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method, comprising:
capturing a first image of a calibration target with a user-facing camera of a head-mounted display (HMD);
determining an imaging parameter of the user-facing camera of the HMD based on the first image of the calibration target, the imaging parameter representing at least one physical characteristic of the user-facing camera;
capturing a second image of the calibration target with the user-facing camera of the HMD; and
determining a position relative to the user-facing camera of a light source of the HMD based on the second image and the imaging parameter of the user-facing camera.

2. The method as in claim 1, wherein the calibration target is external to the HMD.

3. The method as in claim 1, wherein the calibration target includes a set of light-emitting diodes (LEDs).

4. The method as in claim 3, wherein, in the first image, at least one LED of the set of LEDs of the calibration target are turned on.

5. The method as in claim 3, wherein, in the second image, the set of LEDs are turned off.

6. The method as in claim 1, wherein determining the imaging parameter of the user-facing camera of the HMD includes:
defining a value of a cost function that indicates a deviation of a predicted image point from an observed image point, the cost function depending on an imaging parameter of the user-facing camera; and
finding, as the imaging parameter, a reducing imaging parameter of the user-facing camera that reduces the value of the cost function below a nominal value of the cost function.

7. The method as in claim 6, wherein the cost function further depends on a rotation and translation of the user-facing camera relative to a base position of the calibration target; and
wherein the method further comprises:
finding a rotation and translation of the user-facing camera relative to the base position of the calibration target that reduces the value of the cost function below the nominal value of the cost function.

8. The method as in claim 1, wherein the calibration target is mounted on a linear rail and is configured to move in a direction away from or toward the user-facing camera.

9. The method as in claim 8, wherein capturing the first image of a calibration target includes:
capturing the first image of the calibration target at a base position with the user-facing camera;
moving the calibration target to a secondary position; and
capturing a secondary image of the calibration target at the secondary position with the user-facing camera;
wherein the imaging parameter of the user-facing camera of the HMD is determined based on the first image and the secondary image.

10. The method as in claim 8, wherein a mounting error results in a rotation of the calibration target about a base position of the calibration target; and
wherein determining the imaging parameter of the user-facing camera of the HMD includes:
defining a value of a cost function that indicates a deviation of a predicted image point from an observed image point, the cost function depending on an imaging parameter of the user-facing camera and the rotation of the calibration target about the base position of the calibration target; and
finding, as the imaging parameter, a reducing imaging parameter of the user-facing camera and a rotation of the calibration target about the base position of the calibration target that reduce the value of the cost function below a nominal value of the cost function.

11. The method as in claim 1, wherein the user-facing camera is a first user-facing camera; and
wherein the method further comprises:
obtaining a further image of the calibration target with a second user-facing camera of the HMD;
determining an imaging parameter of the second user-facing camera of the HMD based on the further image of the calibration target, the imaging parameter of the second user-facing camera defining at least one physical characteristic of the second user-facing camera; and
determining a relative pose between the first user-facing camera and the second user-facing camera.

12. The method as in claim 1, wherein capturing the second image of the calibration target with the user-facing camera of the HMD includes:
capturing an image of a reflection of the light source of the HMD on the calibration target using the user-facing camera in a pose.

13. The method as in claim 12, wherein the image of the reflection of the light source of the HMD on the calibration target is a first image of the reflection of the light source of the HMD on the calibration target and the pose is a first pose; and
wherein the method further comprises:
capturing a second image of the reflection of the light source of the HMD on the calibration target using the user-facing camera in a second pose.

14. A computer program product comprising a nontransitory storage medium, the computer program product including code that, when executed by processing circuitry, causes the processing circuitry to perform the method as in claim 1.

15. A system, comprising:
a calibration target;
a mount for the calibration target;
a jig configured to mount a head-mounted display (HMD) such that a user-facing camera of the HMD faces the calibration target; and
processing circuitry configured to:
capture a first image of the calibration target with a user-facing camera of a head-mounted display (HMD);
determine an imaging parameter of the user-facing camera of the HMD based on the first image of the calibration target, the imaging parameter representing at least one physical characteristic of the user-facing camera;
capture a second image of the calibration target with the user-facing camera of the HMD; and
determine a position relative to the user-facing camera of a light source of the HMD based on the second image and the imaging parameter of the user-facing camera.

16. The system as in claim 15, wherein the processing circuitry configured to determine the imaging parameter of the user-facing camera of the HMD is further configured to:
define a value of a cost function that indicates a deviation of a predicted image point from an observed image point, the cost function depending on an imaging parameter of the user-facing camera; and
find, as the imaging parameter, a reducing imaging parameter of the user-facing camera that reduces the value of the cost function below a nominal value of the cost function.

17. The system as in claim 16, wherein the cost function further depends on a rotation and translation of the user-facing camera relative to a base position of the calibration target; and
wherein the processing circuitry is further configured to:
find a rotation and translation of the user-facing camera relative to the base position of the calibration target that reduces the value of the cost function below the nominal value of the cost function.

18. The system as in claim 15, wherein the calibration target is mounted on a linear rail and is configured to move in a direction away from or toward the user-facing camera.

19. The system as in claim 18, wherein the processing circuitry configured to capture the first image of a calibration target is further configured to:
capture the first image of the calibration target at a base position with the user-facing camera;
move the calibration target to a secondary position; and
capture a secondary image of the calibration target at the secondary position with the user-facing camera;
wherein the imaging parameter of the user-facing camera of the HMD is determined based on the first image and the secondary image.

20. The system as in claim 18, wherein a mounting error results in a rotation of the calibration target about a base position of the calibration target; and
wherein the processing circuitry configured to determine the imaging parameter of the user-facing camera of the HMD is further configured to:
define a value of a cost function that indicates a deviation of a predicted image point from an observed image point, the cost function depending on an imaging parameter of the user-facing camera and the rotation of the calibration target about the base position of the calibration target; and
find, as the imaging parameter, a reducing imaging parameter of the user-facing camera and a rotation of the calibration target about the base position of the calibration target that reduce the value of the cost function below a nominal value of the cost function.

21. The system as in claim 15, wherein the user-facing camera is a first user-facing camera; and
wherein the processing circuitry is further configured to:
obtain a further image of the calibration target with a second user-facing camera of the HMD;
determine an imaging parameter of the second user-facing camera of the HMD based on the further image of the calibration target, the imaging parameter of the second user-facing camera defining at least one physical characteristic of the second user-facing camera; and
determine a relative pose between the first user-facing camera and the second user-facing camera.

22. The system as in claim 15, wherein the processing circuitry configured to capture the second image of the calibration target with the user-facing camera of the HMD is further configured to:
capture an image of a reflection of the light source of the HMD on the calibration target using the user-facing camera in a pose.

23. The system as in claim 22, wherein the image of the reflection of the light source of the HMD on the calibration target is a first image of the reflection of the light source of the HMD on the calibration target and the pose is a first pose; and
wherein the processing circuitry is further configured to:
capture a second image of the reflection of the light source of the HMD on the calibration target using the user-facing camera in a second pose.
